(19) United States
(12) Patent Application Publication
(10) Pub. No.: US 2024/0303745 A1
(43) Pub. Date: Sep. 12, 2024

(54) CUSTOMIZABLE PRESENTATION FOR WALKING A CUSTOMER THROUGH AN INSURANCE CLAIMS EXPERIENCE

(71) Applicant: STATE FARM MUTUAL AUTOMOBILE INSURANCE COMPANY, Bloomington, IL (US)

(72) Inventors: Brian Fields, Phoenix, AZ (US); Nathan L. Tofte, Downs, IL (US); Joseph Robert Brannan, Bloomington, IL (US); Vicki King, Bloomington, IL (US); Justin Davis, Bloomington, IL (US)

(21) Appl. No.: 18/198,629

(22) Filed: May 17, 2023

Related U.S. Application Data
(60) Provisional application No. 63/486,692, filed on Feb. 24, 2023.
(60) Provisional application No. 63/488,848, filed on Mar. 7, 2023.
(60) Provisional application No. 63/452,820, filed on Mar. 17, 2023.

(51) Int. Cl. G06Q 40/08; G06N 5/043; G06Q 30/015

(52) U.S. Cl. CPC G06Q 40/08; G06N 5/043; G06Q 30/015

(57) ABSTRACT

A computer system may include one or more processors configured to: (1) obtain insurance claim information; (2) generate, via an ML chatbot (or voice bot), the customized presentation based upon the insurance claim information; and/or (3) provide, via the ML chatbot, the customized presentation to a user device, such as a visual depiction and/or a verbal description of the customized presentation.

### CROSS-REFERENCE TO RELATED APPLICATIONS

This application claims priority to and the benefit of the filing date of (1) provisional U.S. Patent Application No. 63/486,692 entitled “CUSTOMIZABLE PRESENTATION FOR WALKING A CUSTOMER THROUGH AN INSURANCE CLAIMS EXPERIENCE,” filed on Feb. 24, 2023; (2) provisional U.S. Patent Application No. 63/488,848 entitled “CUSTOMIZABLE PRESENTATION FOR WALKING A CUSTOMER THROUGH AN INSURANCE CLAIMS EXPERIENCE,” filed on Mar. 7, 2023; and (3) provisional U.S. Patent Application No. 63/452,820 entitled “CUSTOMIZABLE PRESENTATION FOR WALKING A CUSTOMER THROUGH AN INSURANCE CLAIMS EXPERIENCE,” filed on Mar. 17, 2023. The entire contents of each of which is hereby expressly incorporated herein by reference.

### FIELD OF THE INVENTION

The present disclosure generally relates to walking a customer through a claims experience, and more particularly, creating a customized presentation that walks the customer though the insurance claims experience.

### BACKGROUND

Upon experiencing a loss and/or damage to an asset covered by an insurance policy, a policyholder may wish to file a claim for reimbursement and/or compensation. Based upon the type of claim or other factors which may be specific to the loss, it may not be apparent what steps and/or information filing a claim requires. Filing a deficient claim due to inexperience with the claims filing process may risk the effectiveness and/or outcome of the claim. The conventional claims filing instructional techniques may include additional ineffectiveness, inefficiencies, encumbrances, and/or other drawbacks.

### SUMMARY

The present embodiments may relate to, inter alia, systems and methods for generating a customized presentation for filing an insurance claim using machine learning (ML) and/or artificial intelligence (AI).

In one aspect, computer-implemented method for generating a customized presentation for filing an insurance claim using machine learning (ML) may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. For example, in one instance, the computer-implemented method may include: (1) obtaining, by one or more processors, insurance claim information; (2) generating, by the one or more processors via an ML chatbot (or voice bot), the customized presentation based upon the insurance claim information; and/or (3) providing, by the one or more processors via the ML chatbot, the customized presentation to a user device. The method may include additional, less, or alternate functionality or actions, including those discussed elsewhere herein.

In another aspect, a computer system for generating a customized presentation for filing an insurance claim using machine learning (ML) may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. For example, in one instance, the computer system may include one or more processors configured to: (1) obtain insurance claim information; (2) generate, via an ML chatbot (or voice bot), the customized presentation based upon the insurance claim information; and/or (3) provide, via the ML chatbot, the customized presentation to a user device. The computer system may include additional, less, or alternate functionality, including that discussed elsewhere herein.

In another aspect, a non-transitory computer-readable medium storing processor-executable instructions that, when executed by one or more processors, cause the one or more processors to: (1) obtain insurance claim information; (2) generate, via a machine learning (ML) chatbot (or voice bot), the customized presentation based upon the insurance claim information; and/or (3) provide, via the ML chatbot, the customized presentation to a user device. The instructions may direct additional, less, or alternate functionality, including that discussed elsewhere herein.

In another aspect, a computer-implemented method for generating a customized presentation for filing an insurance claim using artificial intelligence (AI) may be provided. The computer-implemented method may be implemented via one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. For example, in one instance, the computer-implemented method may include: (1) obtaining, by one or more processors, insurance claim information; (2) generating, by the one or more processors via an AI chatbot (or voice bot), the customized presentation based upon the insurance claim information; and/or (3) providing, by the one or more processors via the AI chatbot, the customized presentation to a user device. The method may include additional, less, or alternate functionality or actions, including those discussed elsewhere herein.

In another aspect, a computer system for generating a customized presentation for filing an insurance claim using artificial intelligence (AI) may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots or chatbots, ChatGPT bots, and/or other electronic or electrical components, which may be in wired or wireless communication with one another. For example, in one instance, the computer system may include one or more processors configured to: (1) obtain insurance claim information; (2) generate, via an AI chatbot (or voice bot), the customized presentation based upon the insurance claim information; and/or (3) provide, via the AI chatbot, the customized presentation to a user device. The computer system may include additional, less, or alternate functionality, including that discussed elsewhere herein.

In another aspect, a non-transitory computer-readable medium storing processor-executable instructions that, when executed by one or more processors, cause the one or more processors to: (1) obtain insurance claim information; (2) generate, via an artificial intelligence (AI) chatbot (or voice bot), the customized presentation based upon the insurance claim information; and/or (3) provide, via the AI chatbot, the customized presentation to a user device. The instructions may direct additional, less, or alternate functionality, including that discussed elsewhere herein.

Additional, alternate and/or fewer actions, steps, features and/or functionality may be included in one aspect and/or embodiments, including those described elsewhere herein.

### BRIEF DESCRIPTION OF THE DRAWINGS

The figures described below depict various aspects of the applications, methods, and systems disclosed herein. It should be understood that each figure depicts one embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 depicts a block diagram of an exemplary computer system in which methods and systems for generating a customized presentation for filing an insurance claim are implemented.

FIG. 2 depicts a combined block and logic diagram for exemplary training of an ML chatbot model.

FIG. 3 depicts a combined block and logic diagram of an exemplary enterprise server generating a customized presentation using generative AI/ML.

FIG. 4A depicts a block diagram of an exemplary computer system for generating a customized presentation for filing an insurance claim.

FIG. 4B depicts a block diagram of an exemplary mobile application for generating a customized presentation for filing an insurance claim.

FIG. 4C depicts a block diagram of an exemplary customized presentation for filing an insurance claim.

FIG. 5 depicts a flow diagram of an exemplary computer-implemented method for generating a customized presentation for filing an insurance claim using machine learning (ML).

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

### Overview

The computer systems and methods disclosed herein generally relate to, inter alia, methods and systems for generating a customized presentation for filing an insurance claim using machine learning (ML) and/or artificial intelligence (AI).

Some embodiments may use techniques to obtain insurance claim information which may include one or more of: (i) a type of insurance claim, (ii) a user profile, and/or (iii) state requirements. An ML and/or AI chatbot (or voice bot) may generate the customized presentation based upon the insurance claim information. The AI and/or ML chatbot (or voice bot) may provide the customized presentation to a user device.

### Exemplary Computing Environment

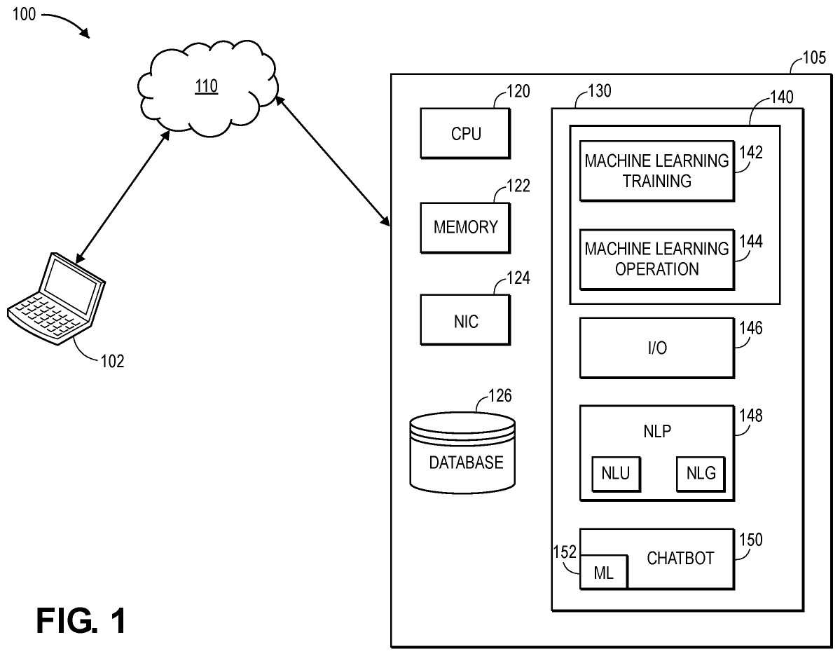

FIG. 1 depicts an exemplary computing environment 100 in which methods and systems for generating a customized presentation for filing an insurance claim may be performed, in accordance with various aspects discussed herein.

In the exemplary aspect of FIG. 1, the computing environment 100 includes a user device 102. In various aspects, the user device 102 comprises one or more computers, which may comprise multiple, redundant, or replicated client computers accessed by one or more users. The computing environment 100 may further include an electronic network 110 communicatively coupling other aspects of the computing environment 100.

The user device 102 may be any suitable device and include one or more mobile devices, wearables, smart watches, smart contact lenses, smart glasses, augmented reality glasses, virtual reality headsets, mixed or extended reality glasses or headsets, voice bots or chatbots 150, ChatGPT bots, and/or other electronic or electrical component. The user device 102 may include a memory and a processor for, respectively, storing and executing one or more modules. The memory may include one or more suitable storage media such as a magnetic storage device, a solid-state drive, random access memory (RAM), etc. The user device 102 may access services or other components of the computing environment 100 via the network 110.

As described herein and in one aspect, one or more servers 105 may perform the functionalities as part of a cloud network or may otherwise communicate with other hardware or software components within one or more cloud computing environments to send, retrieve, or otherwise analyze data or information described herein. For example, certain in aspects of the present techniques, the computing environment 100 may include an on-premise computing environment, a multi-cloud computing environment, a public cloud computing environment, a private cloud computing environment, and/or a hybrid cloud computing environment. For example, an entity (e.g., a business) selling insurance may host one or more services in a public cloud computing environment (e.g., Alibaba Cloud, Amazon Web Services (AWS), Google Cloud, IBM Cloud, Microsoft Azure, etc.). The public cloud computing environment may be a traditional off-premise cloud (i.e., not physically hosted at a location owned/controlled by the business). Alternatively, or in addition, aspects of the public cloud may be hosted on-premise at a location owned/controlled by an enterprise providing insurance. The public cloud may be partitioned using visualization and multi-tenancy techniques and may include one or more infrastructure-as-a-service (IaaS) and/or platform-as-a-service (PaaS) services.

The network 110 may comprise any suitable network or networks, including a local area network (LAN), wide area network (WAN), Internet, or combination thereof. For example, the network 110 may include a wireless cellular service (e.g., 4G, 5G, etc.). Generally, the network 110 enables bidirectional communication between the user device 102 and the servers 105. In one aspect, network 110 may comprise a cellular base station, such as cell tower(s), communicating to the one or more components of the computing environment 100 via wired/wireless communications based on any one or more of various mobile phone standards, including NMT, GSM, CDMA, UMMTS, LTE, 5G, or the like. Additionally or alternatively, network 110 may comprise one or more routers, wireless switches, or other such wireless connection points communicating to the components of the computing environment 100 via wireless communications based on any one or more of various wireless standards, including by non-limiting example, IEEE 802.11a/b/c/g (WIFI), Bluetooth, and/or the like.

The processor 120 may include one or more suitable processors (e.g., central processing units (CPUs) and/or graphics processing units (GPUs)). The processor 120 may be connected to the memory 122 via a computer bus (not depicted) responsible for transmitting electronic data, data packets, or otherwise electronic signals to and from the processor 120 and memory 122 in order to implement or perform the machine-readable instructions, methods, processes, elements or limitations, as illustrated, depicted, or described for the various flowcharts, illustrations, diagrams, figures, and/or other disclosure herein. The processor 120 may interface with the memory 122 via a computer bus to execute an operating system (OS) and/or computing instructions contained therein, and/or to access other services/aspects. For example, the processor 120 may interface with the memory 122 via the computer bus to create, read, update, delete, or otherwise access or interact with the data stored in the memory 122 and/or a database 126.

The memory 122 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 122 may store an operating system (OS) (e.g., Microsoft Windows, Linux, UNIX, etc.) capable of facilitating the functionalities, apps, methods, or other software as discussed herein.

The memory 122 may store a plurality of computing modules 130, implemented as respective sets of computer-executable instructions (e.g., one or more source code libraries, trained ML models such as neural networks, convolutional neural networks, etc.) as described herein.

In general, a computer program or computer based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 120 (e.g., working in connection with the respective operating system in memory 122) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang. Python, C, C++, C#, Objective-C, Java, Scala, ActionScript, JavaScript, HTML, CSS, XML, etc.).

The database 126 may be a relational database, such as Oracle, DB2, MySQL, a NoSQL based database, such as MongoDB, or another suitable database. The database 126 may store data and be used to train and/or operate one or more ML/AI models, chatbots 150, and/or voice bots.

In one aspect, the computing modules 130 may include an ML module 140. The ML module 140 may include ML training module (MLTM) 142 and/or ML operation module (MLOM) 144. In some embodiments, at least one of a plurality of ML methods and algorithms may be applied by the ML module 140, which may include, but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of ML, such as supervised learning, unsupervised learning, and reinforcement learning. In one aspect, the ML based algorithms may be included as a library or package executed on server(s) 105. For example, libraries may include the TensorFlow based library, the PyTorch library, and/or the scikit-learn Python library.

In one embodiment, the ML module 140 employs supervised learning, which involves identifying patterns in existing data to make predictions about subsequently received data. Specifically, the ML module is “trained” (e.g., via MLTM 142) using training data, which includes example inputs and associated example outputs. Based upon the training data, the ML module 140 may generate a predictive function which maps outputs to inputs and may utilize the predictive function to generate ML outputs based upon data inputs. The exemplary inputs and exemplary outputs of the training data may include any of the data inputs or ML outputs described above. In the exemplary embodiments, a processing element may be trained by providing it with a large sample of data with known characteristics or features.

In another embodiment, the ML module 140 may employ unsupervised learning, which involves finding meaningful relationships in unorganized data. Unlike supervised learning, unsupervised learning does not involve user-initiated training based upon example inputs with associated outputs. Rather, in unsupervised learning, the ML module 140 may organize unlabeled data according to a relationship determined by at least one ML method/algorithm employed by the ML module 140. Unorganized data may include any combination of data inputs and/or ML outputs as described above.

In yet another embodiment, the ML module 140 may employ reinforcement learning, which involves optimizing outputs based upon feedback from a reward signal. Specifically, the ML module 140 may receive a user-defined reward signal definition, receive a data input, utilize a decision-making model to generate the ML output based upon the data input, receive a reward signal based upon the reward signal definition and the ML output, and alter the decision-making model so as to receive a stronger reward signal for subsequently generated ML outputs. Other types of ML may also be employed, including deep or combined learning techniques.

The MLTM 142 may receive labeled data at an input layer of a model having a networked layer architecture (e.g., an artificial neural network, a convolutional neural network, etc.) for training the one or more ML models. The received data may be propagated through one or more connected deep layers of the ML model to establish weights of one or more nodes, or neurons, of the respective layers. Initially, the weights may be initialized to random values, and one or more suitable activation functions may be chosen for the training process. The present techniques may include training a respective output layer of the one or more ML models. The output layer may be trained to output a prediction, for example.

The MLOM 144 may comprising a set of computer-executable instructions implementing ML loading, configuration, initialization and/or operation functionality. The MLOM 144 may include instructions for storing trained models (e.g., in the electronic database 126). As discussed, once trained, the one or more trained ML models may be operated in inference mode, whereupon when provided with de novo input that the model has not previously been provided, the model may output one or more predictions, classifications, etc., as described herein.

In one aspect, the computing modules 130 may include an input/output (I/O) module 146, comprising a set of computer-executable instructions implementing communication functions. The I/O module 146 may include a communication component configured to communicate (e.g., send and receive) data via one or more external/network port(s) to one or more networks or local terminals, such as computer network 110 and/or the user device 102 (for rendering or visualizing) described herein. In one aspect, servers 105 may include a client-server platform technology such as ASP.NET, Java J2EE, Ruby on Rails, Node.js, a web service or online API, responsive for receiving and responding to electronic requests.

I/O module 146 may further include or implement an operator interface configured to present information to an administrator or operator and/or receive inputs from the administrator and/or operator. An operator interface may provide a display screen. I/O module 146 may facilitate I/O components (e.g., ports, capacitive or resistive touch sensitive input panels, keys, buttons, lights, LEDs), which may be directly accessible via, or attached to, servers 105 or may be indirectly accessible via or attached to the user device 102. According to one aspect, an administrator or operator may access the servers 105 via the user device 102 to review information, make changes, input training data, initiate training via the MLTM 142, and/or perform other functions (e.g., operation of one or more trained models via the MLOM 144).

In one aspect, the computing modules 130 may include one or more NLP modules 148 comprising a set of computer-executable instructions implementing NLP, natural language understanding (NLU) and/or natural language generator (NLG) functionality. The NLP module 148 may be responsible for transforming the user input (e.g., unstructured conversational input such as speech or text) to an interpretable format. The NLP module may include NLU processing to understand the intended meaning of utterances, among other things. The NLP module 148 may include NLG which may provide text summarization, machine translation, and dialog where structured data is transformed into natural conversational language (i.e., unstructured) for output to the user.

In one aspect, the computing modules 130 may include one or more chatbots and/or voice bots 150 which may be programmed to simulate human conversation, interact with users, understand their needs, generate content (e.g., a customized presentation), and/or recommend an appropriate line of action with minimal and/or no human intervention, among other things. This may include providing the best response of any query that it receives and/or asking follow-up questions.

In some embodiments, the voice bots or chatbots 150 discussed herein may be configured to utilize AI and/or ML techniques. For instance, the voice bot or chatbot 150 may be a ChatGPT chatbot. The voice bot or chatbot 150 may employ supervised or unsupervised machine learning techniques, which may be followed or used in conjunction with reinforced or reinforcement learning techniques. The voice bot or chatbot 150 may employ the techniques utilized for ChatGPT. The voice bot or chatbot may deliver various types of output for user consumption in certain embodiments, such as verbal or audible output, a dialogue output, text or textual output (such as presented on a computer or mobile device screen or display), visual or graphical output, and/or other types of outputs.

Noted above, in some embodiments, a chatbot 150 or other computing device may be configured to implement ML, such that server 105 “learns” to analyze, organize, and/or process data without being explicitly programmed. ML may be implemented through ML methods and algorithms (“ML methods and algorithms”). In one exemplary embodiment, the ML module 140 may be configured to implement ML methods and algorithms.

For example, in one aspect, the server 105 may initiate a chatbot session over the network 110 with a user via a user device 102, e.g., to provide help to the user of the user device 120. The chatbot 150 may receive utterances from the user, i.e., the input from the user from which the chatbot 150 needs to derive intents from. The utterances may be processed using NLP module 148 and/or ML module 140 via one or more ML models to recognize what the user says, understand the meaning, determine the appropriate action, and/or respond with language (e.g., via text, audio, video, multimedia, etc.) the user can understand.

In one aspect, the server 105 may host and/or provide an application (e.g., a mobile application) and/or website configured to provide the application to receive claim submission information from a user via user device 120. In one aspect, the server 105 may store code in memory 122 which when executed by CPU 120 may provide the website and/or application.

The server 105 may store the claim submission information in the database 126. The data may be cleaned, labeled, vectorized, weighted and/or otherwise processed, especially processing suitable for data used in any aspect of ML.

In a further aspect, anytime the server 105 receives claim information and/or generates the customized presentation, it may be stored in the database 126. In one aspect, the server 105 may use the stored data to generate, train and/or retrain one or more ML models and/or chatbots 150, and/or for any other suitable purpose.

In operation, ML model training module 142 may access database 126 or any other data source for training data suitable to generate one or more ML models to generate the customized presentation, e.g., an ML chatbot 152. The training data may be sample data with assigned relevant and comprehensive labels (classes or tags) used to fit the parameters (weights) of an ML model with the goal of training it by example. In one aspect, training data may include historical data from past claim information and/or customized presentations. The historical data may include the type of insurance claim, user profiles, state requirements for the claim, as well as any other suitable training data. In one aspect, once an appropriate ML model is trained and validated to provide accurate predictions and/or responses, e.g., the ML chatbot 152 generated by MLTM 142, the trained model and/or ML chatbot 152 may be loaded into MLOM 144 at runtime, may process the user inputs and/or utterances, and may generate as an output conversational dialog and/or a customized presentation.

In one aspect, the chatbot 150 (e.g., an AI chatbot) and/or the ML chatbot 152 may include one or more ML models trained to generate one or more types of content for a customized presentation, such as text component, audio component, images/video, slides, virtual reality, augmented reality, mixed reality component, multimedia, blockchain and/or metaverse content, as well as any other suitable content.

While various embodiments, examples, and/or aspects disclosed herein may include training and generating one or more ML models and/or ML chatbot 152 for the server 105 to load at runtime, it is also contemplated that one or more appropriately trained ML models and/or ML chatbot 152 may already exist (e.g., in database 126) such that the server 105 may load an existing trained ML model and/or ML chatbot 152 at runtime. It is further contemplated that the server 105 may retrain, update and/or otherwise alter an existing ML model and/or ML chatbot 152 before loading the model at runtime.

Although the computing environment 100 is shown to include one user device 102, one server 105, and one network 110, it should be understood that different numbers of user devices 102, networks 110, and/or servers 105 may be utilized. In one example, the computing environment 100 may include a plurality of servers 105 and hundreds or thousands of user devices 102, all of which may be interconnected via the network 110. Furthermore, the database storage or processing performed by the one or more servers 105 may be distributed among a plurality of servers 105 in an arrangement known as “cloud computing.” This configuration may provide various advantages, such as enabling near real-time uploads and downloads of information as well as periodic uploads and downloads of information.

The computing environment 100 may include additional, fewer, and/or alternate components, and may be configured to perform additional, fewer, or alternate actions, including components/actions described herein. Although the computing environment 100 is shown in FIG. 1 as including one instance of various components such as user device 102, server 105, and network 110, etc., various aspects include the computing environment 100 implementing any suitable number of any of the components shown in FIG. 1 and/or omitting any suitable ones of the components shown in FIG. 1. For instance, information described as being stored at server database 126 may be stored at memory 122, and thus database 126 may be omitted. Moreover, various aspects include the computing environment 100 including any suitable additional component(s) not shown in FIG. 1, such as but not limited to the exemplary components described above. Furthermore, it should be appreciated that additional and/or alternative connections between components shown in FIG. 1 may be implemented. As just one example, server 105 and user device 102 may be connected via a direct communication link (not shown in FIG. 1) instead of, or in addition to, via network 130.

### Exemplary Training of the Ml Chatbot Model

An enterprise may be able to use programmable chatbots, such the chatbot 150 and/or the ML chatbot 152 (e.g., ChatGPT), to provide customer service. The chatbot may be capable of understanding customer requests, providing relevant information (e.g., regarding the insurance claims experience), escalating issues, any of which may improve the customer service experience for the customer of the enterprise. In one aspect, the chatbot may be capable of generating a customized presentation which may include text, audio, and/or other components, and walks the customer though the insurance claims experience.

The ML chatbot may include and/or derive functionality from a Large Language Model (LLM). The ML chatbot may be trained on a server, such as server 105, using large training datasets of text which may provide sophisticated capability for natural-language tasks, such as answering questions and/or holding conversations. The ML chatbot may include a general-purpose pretrained LLM which, when provided with a starting set of words (prompt) as an input, may attempt to provide an output (response) of the most likely set of words that follow from the input. In one aspect, the prompt may be provided to, and/or the response received from, the ML chatbot and/or any other ML model, via a user interface of the server. This may include a user interface device operably connected to the server via an I/O module, such as the I/O module 146. Exemplary user interface devices may include a touchscreen, a keyboard, a mouse, a microphone, a speaker, a display, and/or any other suitable user interface devices.

Multi-turn (i.e., back-and-forth) conversations may require LLMs to maintain context and coherence across multiple user utterances, which may require the ML chatbot to keep track of an entire conversation history as well as the current state of the conversation. The ML chatbot may rely on various techniques to engage in conversations with users, which may include the use of short-term and long-term memory. Short-term memory may temporarily store information (e.g., in the memory 122 of the server 105) that may be required for immediate use and may keep track of the current state of the conversation and/or to understand the user's latest input in order to generate an appropriate response. Long-term memory may include persistent storage of information (e.g., on database 126 of the server 105) which may be accessed over an extended period of time. The ML chatbot may use the long-term memory to store information about the user (e.g., preferences, chat history, etc.) which may improve an overall user experience by enabling the ML chatbot to personalize and/or provide more informed responses.

The system and methods to generate and/or train an ML chatbot model (e.g., via the ML module 140 of the server 105) which may be used the an ML chatbot, may consists of three steps: (1) a Supervised Fine-Tuning (SFT) step where a pretrained language model (e.g., an LLM) may be fine-tuned on a relatively small amount of demonstration data curated by human labelers to learn a supervised policy (SFT ML model) which may generate responses/outputs from a selected list of prompts/inputs. The SFT (Supervised Fine-Tuning) ML model may represent a cursory model for what may be later developed and/or configured as the ML chatbot model; (2) a reward model step where human labelers may rank numerous SFT ML model responses to evaluate the responses which best mimic preferred human responses, thereby generating comparison data. The reward model may be trained on the comparison data; and/or (3) a policy optimization step in which the reward model may further fine-tune and improve the SFT ML model. The outcome of this step may be the ML chatbot model using an optimized policy. In one aspect, step one may take place only once, while steps two and three may be iterated continuously, e.g., more comparison data is collected on the current ML chatbot model, which may be used to optimize/update the reward model and/or further optimize/update the policy.

### Supervised Fine-Tuning (Sft) Ml Model

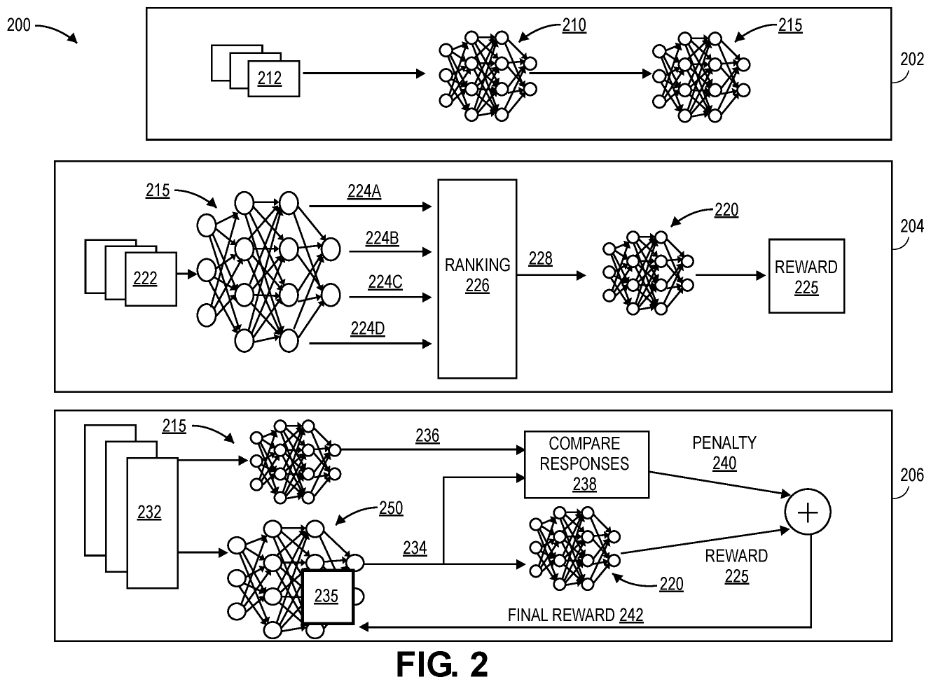

FIG. 2 depicts a combined block and logic diagram 200 for exemplary training of an ML chatbot model, in which the techniques described herein may be implemented, according to some embodiments. Some of the blocks in FIG. 2 may represent hardware and/or software components, other blocks may represent data structures or memory storing these data structures, registers, or state variables (e.g., 212), and other blocks may represent output data (e.g., 225). Input and/or output signals may be represented by arrows labeled with corresponding signal names and/or other identifiers. The methods and systems may include one or more servers 202, 204, 206, such as the server 105 of FIG. 1.

In one aspect, the server 202 may fine-tune a pretrained language model 210. The pretrained language model 210 may be obtained by the server 202 and be stored in a memory, such as the server memory 122 and/or the database 126. The pretrained language model 210 may be loaded into an ML training module, such as MLTL 142, by the server 202 for retraining/fine-tuning. A supervised training dataset 212 may be used to fine-tune the pretrained language model 210 wherein each data input prompt to the pretrained language model 210 may have a known output response for the training the pretrained language model 210. The supervised training dataset 212 may be stored in a memory of the server 202. e.g., the memory 122 and/or the database 126. In one aspect, the data labelers may create the supervised training dataset 212 prompts and appropriate responses. The pretrained language model 210 may be fine-tuned using the supervised training dataset 212, which may results in the SFT ML model 215 which may provide appropriate responses to user prompts once trained. The trained SFT ML model 215 may be stored in a memory of the server 202, e.g., memory 122 and/or database 126.

In one aspect, the supervised training dataset 212 may include prompts and responses which may be relevant to walking a customer through an insurance claims experience. For example, customer prompts may include insurance claim information, such as a type of insurance claim the customer may file. Appropriate responses from the trained SFT ML model 215 may include instructional information regarding bow to file the specific type of insurance claim the customer indicates, among other things.

### Training the Reward Model

In one aspect, training the ML chatbot model 250 may include the server 204 training a reward model 220 to provide as an output a scaler value/reward 225. The reward model 220 may be required to leverage Reinforcement Learning with Human Feedback (RLHF) in which a model (e.g., ML chatbot model 250) learns to produce outputs which maximize its reward 225, and in doing so may provide responses which are better aligned to user prompts.

Training the reward model 220 may include the server 204 providing a single prompt 222 to the SFT ML model 215 as an input. The input prompt 222 may be provided via an input device (e.g., a keyboard) via the I/O module of the server, such as I/O module 146. The prompt 222 may be previously unknown to the SFT ML model 215, e.g., the labelers may generate new prompt data, the prompt 222 may include testing data stored on database 126, and/or any other suitable prompt data. The SFT ML model 215 may generate multiple, different output responses 224A, 224B, 224C, 224D to the single prompt 222. The server 204 may output the responses 224A, 224B, 224C, 224D via an I/O module (e.g., I/O module 146) to a user interface device, such as a display (e.g., as text responses), a speaker (e.g., as audio/voice responses), and/or any other suitable manner of output of the responses 224A, 224B, 224C, 224D for review by the data labelers.

The data labelers may provide feedback via the server 204 on the responses 224A, 224B, 224C, 224D when ranking 226 them from best to worst based upon the prompt-response pairs. The data labelers may rank 226 the responses 224A, 224B, 224C, 224D by labeling the associated data. The ranked prompt-response pairs 228 may be used to train the reward model 220. In one aspect, the server 204 may load the reward model 220 via the ML module (e.g., the ML module 140) and train the reward model 220 using the ranked response pairs 228 the input. The reward model 220 may provide as the output the scalar reward 225.

In one aspect, the scalar reward 225 may include a value numerically representing a human preference for the best and/or most expected response to a prompt, i.e., a higher scaler reward value may indicate the user is more likely to prefer that response, and a lower scalar reward may indicate that the user is less likely to prefer that response. For example, inputting the “winning” prompt-response (i.e., input-output) pair data to the reward model 220 may generate a winning reward. Inputting a “losing” prompt-response pair data to the same reward model 220 may generate a losing reward. The reward model 220 and/or scalar reward 236 may be updated based upon labelers ranking 226 additional prompt-response pairs generated in response to additional prompts 222.

In one example, a data labeler may provide to the SFT ML model 215 as an input prompt 222, “Describe the sky.” The input may be provided by the labeler via the user device 102 over network 110 to the server 204 running a chatbot application utilizing the SFT ML model 215. The SFT ML model 215 may provide as output responses to the labeler via the user device 102: (i) “the sky is above” 224A; (ii) “the sky includes the atmosphere and may be considered a place between the ground and outer space” 224B; and (iii) “the sky is heavenly” 224C. The data labeler may rank 226, via labeling the prompt-response pairs, prompt-response pair 222/224B as the most preferred answer; prompt-response pair 222/224A as a less preferred answer; and prompt-response 222/224C as the least preferred answer. The labeler may rank 226 the prompt-response pair data in any suitable manner. The ranked prompt-response pairs 228 may be provided to the reward model 220 to generate the scalar reward 225.

While the reward model 220 may provide the scalar reward 225 as an output, the reward model 220 may not generate the response (e.g., text). Rather, the scalar reward 225 may be used by a version of the SFT ML model 215 to generate more accurate responses to prompts, i.e., the SFT model 215 may generate the response such as text to the prompt, and the reward model 220 may receive the response to generate a scalar reward 225 of how well humans perceive it. Reinforcement learning may optimize the SFT model 215 with respect to the reward model 220 which may realize the configured ML chatbot model 250.

### RLHF to Train the Ml Chatbot Model

In one aspect, the server 206 may train the ML chatbot model 250 (e.g., via the ML module 140) to generate a response 234 to a random, new and/or previously unknown user prompt 232. To generate the response 234, the ML chatbot model 250 may use a policy 235 (e.g., algorithm) which it learns during training of the reward model 220, and in doing so may transition and/or evolve from the SFT model 215 to the ML chatbot model 250. The policy 235 may represent a strategy that the ML chatbot model 250 may learn to maximize its reward 225. As discussed herein, based upon prompt-response pairs, a human labeler may continuously provide feedback to assist in determining how well the ML chatbot's 250 responses match expected responses to determine rewards 225. The rewards 225 may feed back into the ML chatbot model 250 to evolve the policy 235. Thus, the policy 235 may adjust the parameters of the ML chatbot model 250 based upon the rewards 225 it receives for generating preferred responses. The policy 235 may update as the ML chatbot model 250 provides responses 234 to additional prompts 232.

In one aspect, the response 234 of the ML chatbot model 250 using the policy 235 based upon the reward 225 may be compared 238 to the SFT ML model 215 (which may not use a policy) response 236 of the same prompt 232. The server 206 may compute a penalty 240 based upon the comparison 238 of the responses 234, 236. The penalty 240 may reduce the distance between the responses 234, 236, i.e., a statistical distance measuring how one probability distribution is different from a second, in one aspect the response 234 of the ML chatbot model 250 versus the response 236 of the SFT model 215. Using the penalty 240 to reduce the distance between the responses 234, 236 may avoid the server (e.g., server 206) over-optimizing the reward model 220 and deviating too drastically from the human-intended/preferred response. Without the penalty 240, the ML chatbot model 250 optimizations may result in generating responses 234 which are unreasonable but may still result in the reward model 220 outputting a high reward 225.

In one aspect, the responses 234 of the ML chatbot model 250 using the current policy 235 may be passed by the server 206 to the rewards model 220, which may return the scalar reward 225. The ML chatbot model 250 response 234 may be compared 238 to the SFT ML model 215 response 236 by the server 206 to compute the penalty 240. The server 206 may generate a final reward 242 which may include the scalar reward 225 offset and/or restricted by the penalty 240. The final reward 242 may be provided by the server 206 to the ML chatbot model 250 and may update the policy 235, which in turn may improve the functionality of the ML chatbot model 250.

To optimize the ML chatbot 250 over time, RLHF (Reinforcement Learning with Human Feedback) (via the human labeler feedback may continue ranking 226 responses of the ML chatbot model 250 versus outputs of earlier/other versions of the SFT ML model 215, i.e., providing positive or negative rewards 225. The RLHF may allow the servers (e.g., servers 204, 206) to continue iteratively updating the reward model 220 and/or the policy 235. As a result, the ML chatbot model 250 may be retrained and/or fine-tuned based upon the human feedback via the RLHF process, and throughout continuing conversations may become increasingly efficient.

Although multiple servers 202, 204, 206 are depicted in the exemplary block and logic diagram 200, each providing one of the three steps of the overall ML chatbot model 250 training, fewer and/or additional servers may be utilized and/or may provide the one or more steps of the ML chatbot model 250 training. In one aspect, one server may provide the entire ML chatbot model 250 training.

### Generative AI/ML to Create a Customized Presentation

Generative AI/ML may enable a computer, such as the server 105 of an insurance carrier, to use existing data (e.g., as an input and/or training data) such as text, audio, video, images, and/or code, among other things, to generate new content, such as a presentation customized for a customer of the insurance carrier, via one or more models. Generative ML may include unsupervised and semi-supervised ML algorithms, which may automatically discover and learn patterns in input data. Once trained, e.g., via MLTM 142, a generative ML model may generate content as an output which plausibly may have been drawn from the original input dataset, and may include the content in the customized presentation. In one aspect, an ML chatbot such as ML chatbot 152 may include one or more generative AI/ML models.

Some types of generative AI/ML may include generative adversarial networks (GANs) and/or transformer-based models. In one aspect, the GAN may generate images, visual and/or multimedia content from image and/or text input data. The GAN may include a generative model (generator) and discriminative model (discriminator). The generative model may produce an image which may be evaluated by the discriminative model, and use the evaluation to improve operation of the generative model. The transformer-based model may include a generative pre-trained language model, such as the pre-trained language model used in training the ML chatbot model 250 described herein. Other types of generative AI/ML may use the GAN, the transformer model, and/or other types of models and/or algorithms to generate: (i) realistic images from sketches, which may include the sketch and object category as input to output a synthesized image; (ii) images from text, which may produce images (realistic, paintings, etc.) from textual description inputs; (iii) speech from text, which may use character or phoneme input sequences to produce speech/audio outputs; (iv) audio, which may convert audio signals to two-dimensional representations (spectrograms) which may be processed using algorithms to produced audio; (v) video, which may generate and convert video (i.e., a series of images) using image processing techniques and may include predicting what the next frame in the sequence of frames/video may look like and generating the predicted frame. With the appropriate algorithms and/or training, generative AI/ML may produce various types of multimedia output and/or content which may be incorporated into a customized presentation, e.g., via an AI and/or ML chatbot (or voice bot).

In one aspect, an enterprise may use the AI and/or ML chatbot, such as the trained ML chatbot 152, to generate one or more customized components of the customized presentation to walk the customer through the insurance claims experience. The trained ML chatbot may generate output such as images, video, slides (e.g., a PowerPoint slide), virtual reality, augmented reality, mixed reality, multimedia, blockchain entries, metaverse content, or any other suitable components which may be used in the customized presentation.

In one embodiment, the ML model may be trained to produce images in a two-stage process. In a first stage, a text encoder and an image encoder may be trained on training data of image-text pairs. During training, the ML model receives a list of images and a corresponding list of captions describing the images. Using the data, the encoders may be trained to map the image-text pairs to a vector space whose dimensions represent both features of images and features of the text. This shared vector space may provide the ML model with the ability to translate between text and images and understand how the text maps and/or relates to images based upon the image-text pairs. Through training, the ML model may learn the features of the image, such as objects present in the image, the aesthetic style, the colors and materials, etc.

In one aspect, in the second stage the ML model may generate images from scratch based upon a text input using a diffusion model which learns to generate an image by reversing a gradual noising process. The second stage text input may describe the image to be generated from which the diffusion model may generate the image. During training, the ML model may receive a corrupted, noisy version of the image it is trained to reconstruct as a clean image. This model may be trained to reverse the mapping learned in the first stage via the image encoder, to fill in the necessary details when reversing the noising process to produce a realistic image from the noisy image.

In one embodiment, the transformer-based model, such as that discussed herein with respect to training the ML chatbot 250, may operate on sequences of pixels rather than sequences of text alone, to generate images. In one aspect, an ML model such as ML chatbot 250 may be trained to operate on inputs which may include both image pixels as well as text to produce realistic-looking images based upon short captions. The short captions may specify multiple objects, their colors, textures, respective positions, and other contextual details such as lighting or camera angle. The content the transformer-based ML model generates may be used in the customized presentation to walk a customer through a claims experience.

Once trained, the ML chatbot which may include on one more generative AI/ML models such as those described may be able to generate the customized presentation based upon one or more user prompts, such as claim information. In response, the ML chatbot may generate audio/voice/speech, text, slides, and/or other suitable content which may be included in the customized presentation.

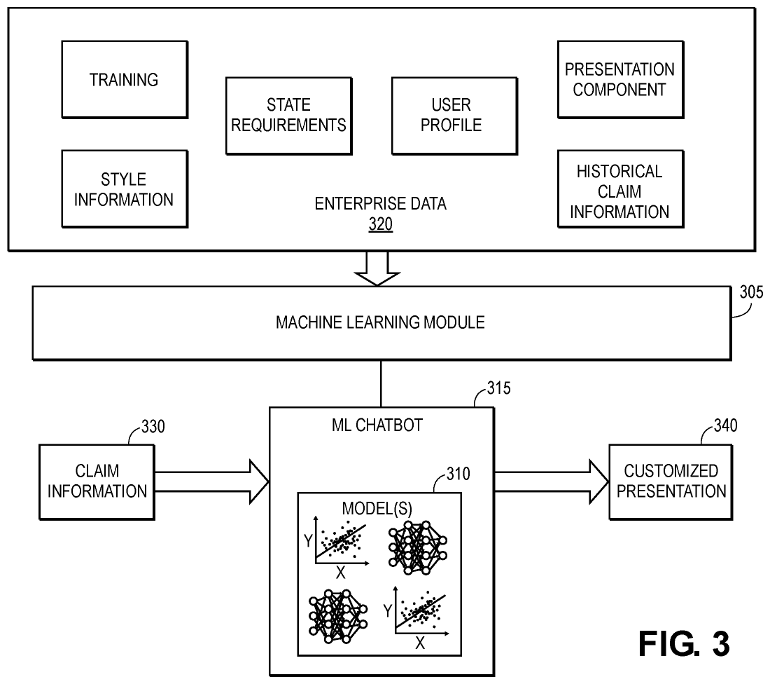

FIG. 3 schematically illustrates how an enterprise server, such as server 105 of an insurance carrier, may use generative AI/ML to create the customized presentation for filing an insurance claim, according to one embodiment. Some of the blocks in FIG. 3 may represent hardware and/or software components (e.g., block 305), other blocks may represent data structures or memory storing these data structures, registers, or state variables (e.g., block 320), and other blocks may represent output data (e.g., block 340). Input signals may be represented by arrows and may be labeled with corresponding signal names.

In one aspect, the ML module 305 may include one or more hardware and/or software components such as ML module 140, MLTM 142, MLOM 144. The ML module 305 may obtain, create, train/fine-tune, retrieve, load, operate and/or save one or more ML models 310, such as generative AI/ML models. In one aspect, an ML chatbot 315 may use, access, be operably connected to and/or otherwise include one or more ML models 310 to generate a customized presentation 340. The ML chatbot 315 may generate the customized presentation 340 in response to receiving claim information 330 as the input.

To generate, train and/or fine-tune the one or more ML models 310, the ML module 305 may use the enterprise data 320 as training data. In one aspect, the enterprise data 320 may include the supervised training dataset 212 for SFT ML model 215 underlying the ML chatbot model 250. The enterprise data 320 may include presentation component data such as images, text, phenomes, audio or other types of data which may be used as inputs as discussed herein for training one or more AI/ML models to generate different types of presentation components. The enterprise data 320 may include style information related to a particular style (e.g., fonts, logos, emblems, colors, etc.) an enterprise would like the customized presentation components to emulate. The enterprise data 320 may include user profile information which may affect customizing the presentation for a particular customer, e.g., what the claim filing experience may look like based upon their specific insurance policy. The enterprise data 320 may include historical claim information, e.g., based upon past claims, what may be relevant to include in the customized presentation 340 for a similar type of claim. The enterprise data 320 may include state requirement data to include location-specific claim information in the customized presentation 340. While the example enterprise data 320 includes indications of various types of data, this is merely an example for ease of illustration only. The enterprise data 320 may include any data relevant to generating the customized presentation 340.

In one aspect, the ML module 305 may load enterprise data 320, e.g., using an MLTM such as MLTM 142, to train one or more ML models 310. The ML module 305 may save the trained ML model 310 in a memory, for example the memory 122 and/or the database 126 of the server 105. At runtime to create the customized presentation 340, the ML module 305 may load one or more ML models 310 and/or ML chatbots 315 in a memory. The server may obtain claim information 330, e.g., as input from a customer via user device 102 and/or from profile data stored in a database, such as database 126, as well as any other suitable manner of obtaining the claim information 330. In one aspect, the customer for which the customized presentation 340 is being generated provides the claim information 330 via the ML chatbot 315, e.g., using a mobile application of the enterprise. The claim information 330 may be provided as an input to the one or more ML models 310 and/or ML chatbots 315. The one or more chatbots 315 and/or ML models 310 may employ one or more AI/ML models (e.g., SFT ML model, GAN, pre-trained language models, etc.) and/or algorithms (e.g., supervised learning, unsupervised learning, semi-supervised learning, and/or reinforcement learning) discussed herein to generate the customized presentation 340. For example, a customer may provide claim information 330 indicating the plan to file a property damage claim due to a tree falling onto their home. The one or more ML models 310 and/or ML chatbots 315 may generate the customized presentation 340 to use enterprise style information such as colors, fonts and/or logos associated with the enterprise insurance carrier, contain images of the customer's actual home, provide information regarding coverage and deductibles associated with their specific insurance policy for property damage due to a fallen tree, provide contact information for local landscaping businesses which may be able to remove the fallen tree, provide contact information for local inspectors associated with the enterprise to survey the damage, among other things.

The enterprise may update and save in a memory, such as the memory 122 and/or the database 126 of the server 105, the enterprise data 320. The ML model 305 may use the updated enterprise data 320 to retrain and/or fine tune the ML model 310 and/or ML chatbot 315. For example, the insurance carrier may create updated enterprise style information which may affect the look of newly generated customized presentations 340. Subsequently, one or more ML models 310 may be retrained (e.g., via MLTM 142) based upon the updated enterprise data 320.

### Exemplary Computer System for Generating a Customized Presentation

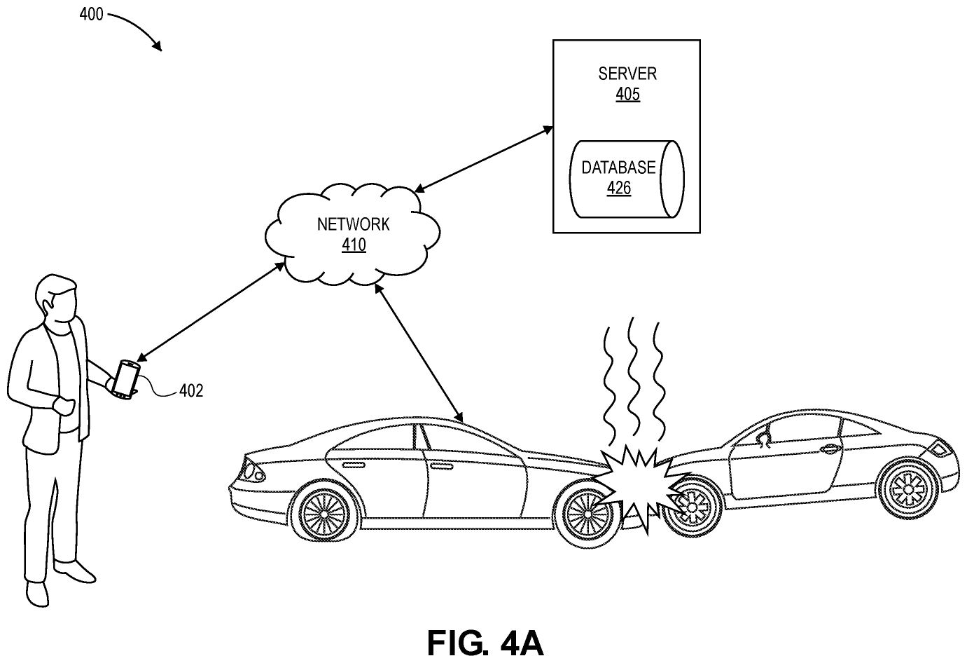

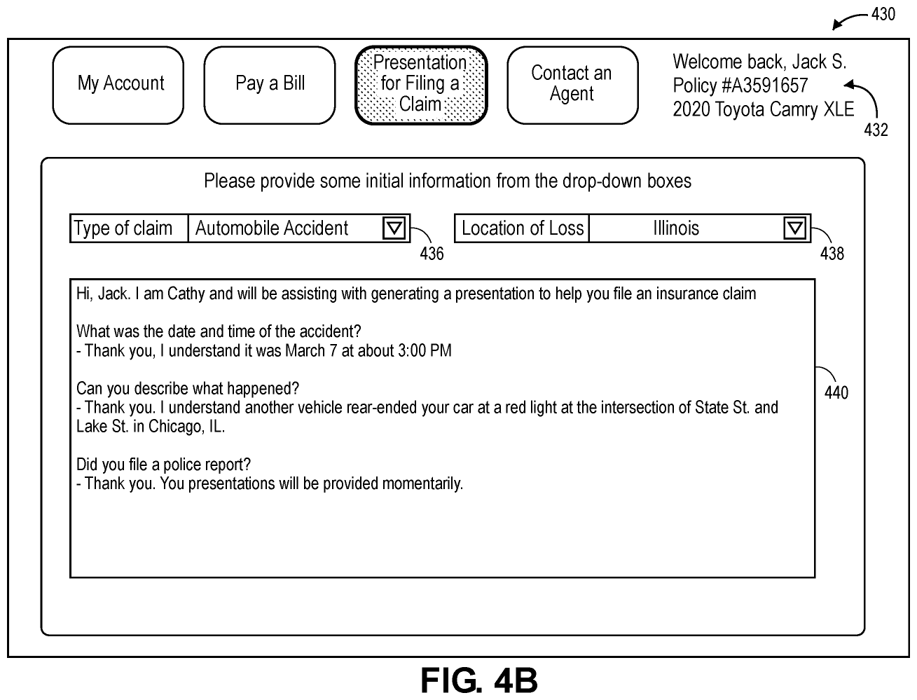

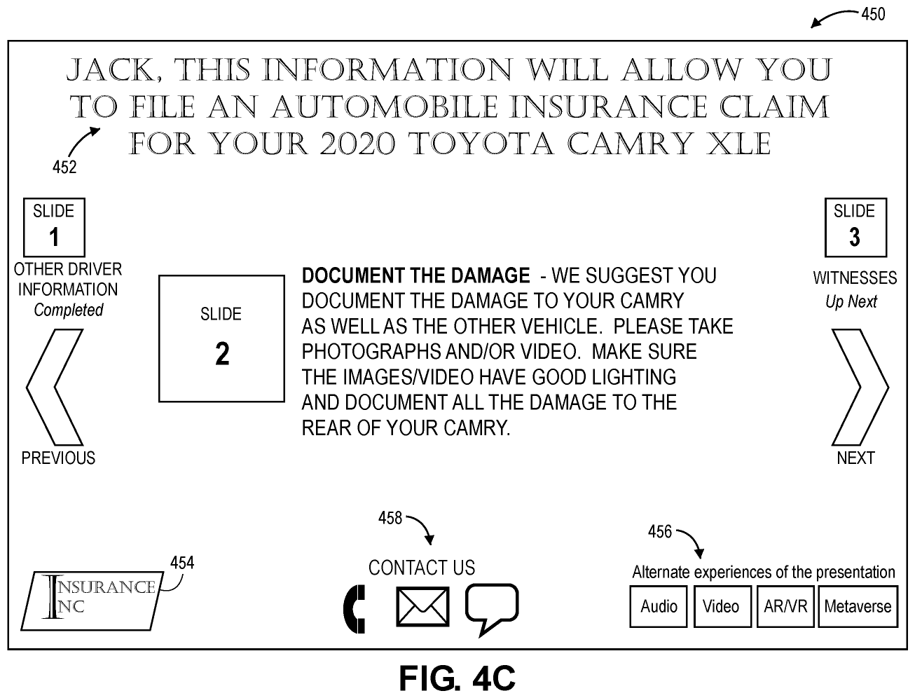

FIG. 4 depicts a block diagram of an exemplary computer system 400 for generating a customized presentation for a customer for filing an insurance claim, according to an embodiment. The computer system may include a user device 402, a network 410, and/or a server 405, such as the user device 102, the network 110 and/or the server 105 of FIG. 1, respectively. The system may include additional, less, or alternate devices, including those discussed elsewhere herein.

An insurance carrier (enterprise) may wish to provide a presentation for a customer as an educational tool which informs the customer what the claims experience may be like, e.g., for the customer who may need to file a specific type of claim, or the customer who may be unfamiliar with the claim filing process. The enterprise may customize the presentation in one or more ways for a specific customer. For example, the presentation may be customized based upon for the type of claim the customer plans to file, the type of loss that has occurred, the type of insurance policy the customer has with the enterprise, among other things.

In the exemplary computer system 400 depicted by FIG. 4A, the insurance customer Jack is involved in an accident and subsequently may request a customized presentation regarding how to file the appropriate insurance claim. Jack may contact the enterprise to request the customized presentation via an enterprise mobile application (app) on his user device 402 (e.g., a smartphone). Additionally or alternatively, Jack may use his user device 402 to access a website of the enterprise hosted on the server 405 to request the customized presentation. In one aspect, Jack may log into his enterprise account via the mobile app and/or website using his user account credentials. The user account credentials may be transmitted by Jack's user device 402 via network 410 to the enterprise server 405. The server 405 may verify Jack's credentials, e.g., using Jack's profile data saved on the server database 426.

FIG. 4B depicts a block diagram of an exemplary mobile application 430 Jack is running on his user device 402 for generating the customized presentation for filing the insurance claim, according to an embodiment. In one aspect, upon verification of the credentials by the server 405, the app 430 may provide Jack access to one or more business functions associated with the enterprise, one of which may include generating the customized presentation 432 explaining the claims experience. To generate the presentation in a customized manner, the server 405 via the app 430 may request some initial claim information from Jack. In one aspect, the app 430 may present a drop-down menu via a GUI 436, 438 of the user device 402 for the Jack to provide the claim information, such as the type of claim and location of the loss. A user of the app may also be able to provide the location and/or state of a potential insurance claim via the app 430 using similar and/or other known techniques, which may include the server 405 and/or app 405 identifying the location of user device 402, e.g., via its GPS signal

In one aspect, once logged into the app 430, some or all of the customer's claim information may be available to the enterprise. In one aspect, based upon Jack's user profile associated with his app credentials, the server 405 may obtain customer data 432 which may include the name, address, date of birth, social security number, insurance policy/policies information (e.g., types of policies, account numbers, coverage information, items covered, etc.), as well as other suitable information.

In one aspect, the server 405 may initiate a chatbot to obtain claim information from the customer and/or the chatbot may be initiated in response to previously receiving the claim information in another fashion, such as via the GUI 436, 438. The chatbot may be an AI chatbot, an ML chatbot 440 such as a ChatGPT chatbot, a voice bot and/or any other suitable chatbot and/or voice bot described herein. In one aspect, the server 405 may select an appropriate chatbot based upon the method of communication with the customer, one or more pieces of information the customer provides to the server 405, and/or other aspects.

The server 405 may train (e.g., via ML module 140 and/or MLTM 142) the ML chatbot 440 to communicate with the customer in a conversational manner without human intervention from the enterprise. Through one or more requests, the ML chatbot 440 may receive claim information from the user (e.g., via the user device 402) which may be pertinent to generating the customized presentation. In one aspect where there has been a loss the customer wishes to report, the claim information may include, but is not limited to, the type of claim, description of the loss and/or events surround the loss, location of the loss, police report information, witness information, etc., as well as any other suitable information.

In one aspect, the server 405 may analyze and/or process the claim information received by the ML chatbot 440 to interpret, understand and/or extract relevant information within one or more customer responses and/or generate additional requests via the ML chatbot 440. In one aspect, the ML chatbot 440 may use NLP for this, which may include NLU and/or NLG, e.g., via an NLP module such as NLP module 148.

Based upon the claim information and/or customer's user profile, among other things, the ML chatbot 440 may generate the customized presentation that explains one or more aspects of the claims experience specific to the customer. The ML chatbot 440 via the server 405 may provide the customized presentation to the customer's user device, such as Jack's smartphone 402.

In one aspect, the customized presentation may include information indicative of one or more of: (i) what information is required for the insurance claim (e.g., description of the loss, location of the loss, supporting information such as photos, etc.), (ii) what/who may be sources of information for the claim (e.g., witnesses to the loss), (iii) how to submit the insurance claim and/or (iv) steps of the insurance claims experience (e.g., inspection of the damaged asset, a settlement offer etc.), and/or other suitable information. In one example, if the loss is due to a vehicle accident a sis the case with Jack, the customized presentation may include information indicating that the customer should obtain insurance information from the other driver, take photographs of the damage, contact the police to file a report, investigate if there are available witnesses and/or recordings of the incident, among other things.

The ML chatbot 440 may generate one or more customized presentation components to include in the presentation, e.g., using generative AI/ML as described herein. In one aspect, the ML chatbot 440 and/or server 405 may obtain one or more components for the customized presentations e.g., components may be stored in the database 426, retrieved from the internet via network 410 and/or obtained in any suitable manner.

The components of the customized presentation may include one or more text components, for example tailoring the presentation using the customer's name, type of claim, information about the insured asset, etc. In one aspect, the customized presentation may include one or more audio components, for example the ML chatbot 152 may include a voice bot which is capable of generating output which may mimic a human voice. In one aspect, the customed presentation may include one or more visual components such as images, video, slides (e.g., PowerPoint slides).

FIG. 4C depicts a block diagram of an exemplary customized slideshow presentation 450 for filing an insurance claim, according to an embodiment. The ML chatbot 440 may generate the slideshow presentation 450 for Jack. The slideshow 450 may contain a customized slideshow header 452 which indicates the Jack's name and that the claim will be an automobile claim for Jack's Camry based upon claim information obtained earlier by the enterprise server 440 from Jack via the app 430 on his mobile device 402. Part of the slideshow 450 describes documenting damage and indicates the damage was to the rear of Jack's Camry, which Jack also indicated in the claim information provided to the chatbot 440 via the app 430 when describing the accident.

In one aspect the customized components may be based upon enterprise style information to provide a look, feel and/or style for the customized presentation such as enterprise colors, fonts, logos, trademarks, slogans, and/or other information associated with the enterprise. For example, the slideshow 450 includes the insurance company's logo 454 and several of the text components, such as header 452, also use the same font as the logo 454.

In one aspect the ML chatbot 440 and/or server 405 may generate a presentation which may be experienced by the customer in one or more formats, e.g., audio, video, virtual reality (VR), augmented reality (AR), mixed reality (MR), extended reality (XR) and/or the metaverse. In the example of FIG. 4C, the slideshow 450 the ML chatbot 440 generates contains links 456 to experience the presentation in other formats such as audio, video, AR/VR and/or in the metaverse. In one aspect, the customer's user device which the customized presentation is delivered to may include a headset, glasses, googles, a head-mounted display and/or the like, any of which may be capable of displaying AR, VR, MR and/or XR content. In one aspect, the customized presentation may include and/or involve a blockchain entry/component, for example adding a copy of the customized presentation in a blockchain entry created by the enterprise server 405. Any type of audio, visual, and/or multimedia suitable for the presentation may be generated by the ML chatbot 440 and/or server 405.

In one aspect, the customized presentation may include help information generated by the ML chatbot 405. In the example according to FIG. 4C, the slideshow 450 contains links 458 to telephone, email and chat contact information. The help information may include contact information for the enterprise, a customer service agent, a specific insurance agent which may service the customer, an AI/ML chatbot, among other things. In one aspect, the help information may include a link to initiate a session with the ML chatbot 440 in which the user may interact with the ML chatbot 440, e.g., via a chat window, a telephone call, a videoconference, and/or any other suitable communication means. The link may be a hyperlink which when selected by the customer, e.g., via user interface on the user device 402 in which the presentation is being experienced, activates a session between the user and the ML chatbot 440 via the associated method of communication. The customer may use the session to interact with the ML chatbot 440 in a conversational manner, e.g., to ask questions and/or file an insurance claim.

In one aspect, a representative of the enterprise may review the customized presentation before the ML chatbot 440 provides the presentation to the customer device. The ML chatbot 440 may provide the presentation to the representative via an enterprise device. In one example, the ML chatbot 440 may generate the customized presentation and store it in a memory of the server 440, such as the database 426 and/or the memory 122 of server 405, or any other suitable manner of providing the presentation to the representative.

### Exemplary Computer-Implemented Method for Generating a Customized Presentation Using Machine Learning

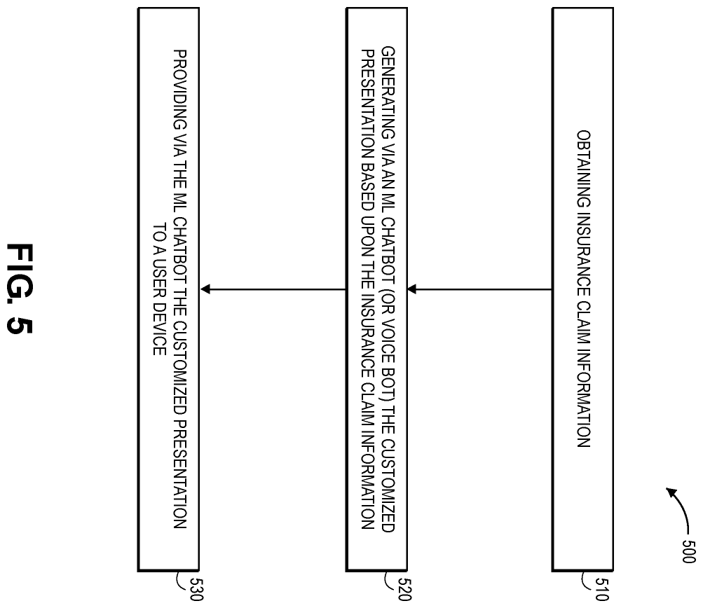

FIG. 5 depicts a flow diagram of an exemplary computer-implemented method 500 for generating a customized presentation for filing an insurance claim using machine learning (ML), according to one embodiment. One or more steps of the computer-implemented method 500 may be implemented as a set of instructions stored on a computer-readable memory and executable on one or more processors. The computer-implemented method 500 of FIG. 5 may be implemented via the exemplary computer environment 100 of FIG. 1.

The computer-implemented method 500 may include: (1) at block 510 obtaining, by one or more processors, insurance claim information; (2) at block 520 generating, by the one or more processors via an ML chatbot (or voice bot), the customized presentation based upon the insurance claim information; and/or (3) at block 530 providing, by the one or more processors via the ML chatbot, the customized presentation to a user device.

In one embodiment of the computer-implemented method 500, the insurance claim information may include one or more of: (i) a type of insurance claim, (ii) a user profile, and/or (iii) state requirements.

In one embodiment of the computer-implemented method 500, generating the customized presentation may include generating, by the one or more processors via the ML chatbot, one or more customized presentation components including one or more of: (i) a text component, (ii) an audio component, (iii) an image component, (iv) a video component, (v) a slide component. (vi) a virtual reality component, (vii) an augmented reality component, (viii) a mixed reality component. (ix) a multimedia component. (x) a blockchain component, and/or (xi) a metaverse component.

In one embodiment, the computer-implemented method 500 may include obtaining, by the one or more processors, enterprise style information wherein the one or more customized presentation components are generated based upon the enterprise style information.

In one embodiment of the computer-implemented method 500, generating the customized presentation may include generating, by the one or more processors via the ML chatbot, customized insurance claim submission information indicating one or more of: (i) required insurance claim information, (ii) sources of insurance claim information, (iii) how to submit the insurance claim, and/or (iv) steps of the insurance claims experience.

In one embodiment of the computer-implemented method 500, generating the customized presentation may include generating, by the one or more processors via the ML chatbot, help information. The help information may include one or more links to initiate an ML chatbot session and the computer-implemented method 500 may further include (1) receiving, by the one or more processors via the ML chatbot from the user device, a request to initiate the ML chatbot session based upon a user interaction with the one or more links via the user device; and/or (2) initiating, by the one or more processors via the ML chatbot, the ML chatbot session with the user device in response to the request to initiate the ML chatbot session.

In one embodiment, the computer-implemented method 500 may include providing, by the one or more processors, the customized presentation to an enterprise device for review by a representative.

In one embodiment of the computer-implemented method 500, the ML chatbot may include one or more of: (i) supervised learning, (ii) unsupervised learning, and/or (iii) reinforcement learning.

It should be understood that not all blocks of the exemplary flow diagram of computer-implemented method 500 are required to be performed. Moreover, the exemplary flow diagram of computer-implemented method 500 is not mutually exclusive (e.g., block(s) from exemplary flow diagram may be performed in any particular implementation).

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as “processing,” “computing.” “calculating.” “determining,” “presenting.” “displaying.” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising.” “includes,” “including.” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

Furthermore, the patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed:

1. A computer-implemented method for generating a customized presentation for filing an insurance claim using machine learning (ML), the method comprising:
obtaining, by one or more processors, insurance claim information;
generating, by the one or more processors via an ML chatbot (or voice bot), the customized presentation based upon the insurance claim information; and
providing, by the one or more processors via the ML chatbot, the customized presentation to a user device.

2. The computer-implemented method of claim 1, wherein the insurance claim information includes one or more of: (i) a type of insurance claim, (ii) a user profile, and/or (iii) state requirements.

3. The computer-implemented method of claim 1, wherein generating the customized presentation comprises:
generating, by the one or more processors via the ML chatbot, one or more customized presentation components including one or more of: (i) a text component, (ii) an audio component, (iii) an image component, (iv) a video component, (v) a slide component, (vi) a virtual reality component, (vii) an augmented reality component, (viii) a mixed reality component, (ix) a multimedia component, (x) a blockchain component, and/or (xi) a metaverse component.

4. The computer-implemented method of claim 3, further comprising:
obtaining, by the one or more processors, enterprise style information,
wherein the one or more customized presentation components are generated based upon the enterprise style information.

5. The computer-implemented method of claim 1, wherein generating the customized presentation comprises:
generating, by the one or more processors via the ML chatbot, customized insurance claim submission information indicating one or more of: (i) required insurance claim information, (ii) sources of insurance claim information, (iii) how to submit the insurance claim, and/or (iv) steps of the insurance claims experience.

6. The computer-implemented method of claim 1, wherein generating the customized presentation comprises:
generating, by the one or more processors via the ML chatbot, help information.

7. The computer-implemented method of claim 6, wherein the help information includes one or more links to initiate an ML chatbot session and the method further comprises:
receiving, by the one or more processors via the ML chatbot from the user device, a request to initiate the ML chatbot session based upon a user interaction with the one or more links via the user device; and
initiating, by the one or more processors via the ML chatbot, the ML chatbot session with the user device in response to the request to initiate the ML chatbot session.

8. The computer-implemented method of claim 1, further comprising:
providing, by the one or more processors, the customized presentation to an enterprise device for review by a representative.

9. The computer-implemented method of claim 1, wherein the ML chatbot includes one or more of: (i) supervised learning, (ii) unsupervised learning, and/or (iii) reinforcement learning.

10. A computer system for generating a customized presentation for filing an insurance claim using machine learning (ML), the computer system comprising:
one or more processors configured to:
obtain insurance claim information;
generate, via an ML chatbot (or voice bot), the customized presentation based upon the insurance claim information; and
provide, via the ML chatbot, the customized presentation to a user device.

11. The computer system of claim 10, wherein the insurance claim information includes one or more of: (i) a type of insurance claim, (ii) a user profile, and/or (iii) state requirements.

12. The computer system of claim 10, wherein to generate the customized presentation, the one or more processors are further configured to:
generate, via the ML chatbot, one or more customized presentation components including one or more of: (i) a text component, (ii) an audio component, (iii) an image component, (iv) a video component, (v) a slide component, (vi) a virtual reality component, (vii) an augmented reality component, (viii) a mixed reality component, (ix) a multimedia component, (x) a blockchain component, and/or (xi) a metaverse component.

13. The computer system of claim 12, wherein the one or more processors are further configured to:
obtain enterprise style information,
wherein the one or more customized presentation components are generated based upon the enterprise style information.

14. The computer system of claim 10, wherein to generate the customized presentation, the one or more processors are further configured to:
generate, via the ML chatbot, customized insurance claim submission information indicating one or more of: (i) required insurance claim information, (ii) sources of insurance claim information, (iii) how to submit the insurance claim, and/or (iv) steps of the insurance claims experience.

15. The computer system of claim 10, wherein to generate the customized presentation, the one or more processors are further configured to;
generate, via the ML chatbot, help information.

16. The computer system of claim 15, wherein the help information includes one or more links to initiate an ML chatbot session and the one or more processors are further configured to:
receive, via the ML chatbot from the user device, a request to initiate the ML chatbot session based upon a user interaction with the one or more links via the user device; and
initiate, via the ML chatbot, the ML chatbot session with the user device in response to the request to initiate the ML chatbot session.

17. The computer system of claim 10, wherein the one or more processors are further configured to:
provide the customized presentation to an enterprise device for review by a representative.

18. The computer system of claim 10, wherein the ML chatbot includes one or more of: (i) supervised learning, (ii) unsupervised learning, and/or (iii) reinforcement learning.

19. A non-transitory computer-readable medium storing processor-executable instructions that, when executed by one or more processors, cause the one or more processors to:
obtain insurance claim information;
generate, via a machine learning (ML) chatbot (or voice bot), the customized presentation based upon the insurance claim information; and
provide, via the ML chatbot, the customized presentation to a user device.

20. The non-transitory computer-readable medium of claim 19, wherein to generate the customized presentation includes instructions that, when executed by the one or more processors, cause the one or more processors to:
generate, via the ML chatbot, one or more customized presentation components including one or more of: (i) a text component, (ii) an audio component, (iii) an image component, (iv) a video component, (v) a slide component, (vi) a virtual reality component, (vii) an augmented reality component, (viii) a mixed reality component, (ix) a multimedia component, (x) a blockchain component, and/or (xi) a metaverse component.
